(19) United States
(12) Patent Application Publication
(10) Pub. No.: US 2007/0295227 A1
(43) Pub. Date: Dec. 27, 2007

(54) Flexible Colander

(75) Inventor: Paolo Raineri, Bergamo (IT)

Correspondence Address: SALTAMAR INNOVATIONS, 30 FERN LANE, SOUTH PORTLAND, ME, 04106, US

(73) Assignee: PAVONI ITALIA S.P.A., Suisio (BG) (IT)

(21) Appl. No.: 11/719,619

(22) PCT Filed: Nov. 21, 2005
(86) PCT No.: PCT/IB05/03479

§ 371 Date: Jul. 2, 2007

(30) Foreign Application Priority Data
Nov. 19, 2004 (IT) MI2004A002223

(51) Int. Cl. A47J 43/24

(52) U.S. Cl. 99/484; 99/495

(57) ABSTRACT

It is described a colander (1) comprising a bowl-shaped container (2) having a plurality of through holes (3) for drainage, that it is wholly made of a flexible material, for example silicone elastomers obtained by a platinum-catalyzed cross-linking process.

This invention relates to a colander wholly made of a flexible material.

Separation of certain foodstuffs, such as pasta or vegetables from cooking water is known to be obtained by using a colander.

Prior art colanders are made of metal, plastic or other inflexible materials.

They generally have the shape of a spherical bowl, into which foodstuffs and cooking water are poured together, and include a plurality of through holes formed on the bottom or side surface of said bowl for draining cooking water as food is strained.

Prior art colanders also have support means, generally a plurality of feet, to assure stability of the colander on a horizontal plane.

Furthermore, these colanders generally have one or more handles for holding them.

However, prior art colanders have various drawbacks.

Particularly, these colanders are rigid and poorly adaptable to various operating conditions.

They further have a large size when not in use and when stored in their cupboards.

Also, the handles of stainless steel colanders tend to heat up during straining, and may cause the user to be burnt thereby.

The object of this invention is to obviate at least some of prior art drawbacks and particularly the drawbacks set out hereinbefore.

This object is achieved by a colander according to the features of claim 1, and by use of an elastomer according to the features of claim 10.

Further advantages may be achieved by the additional features of the dependent claims.

A possible embodiment of the colander, as claimed in the attached claims, will be described hereafter with reference to the accompanying drawings, in which:

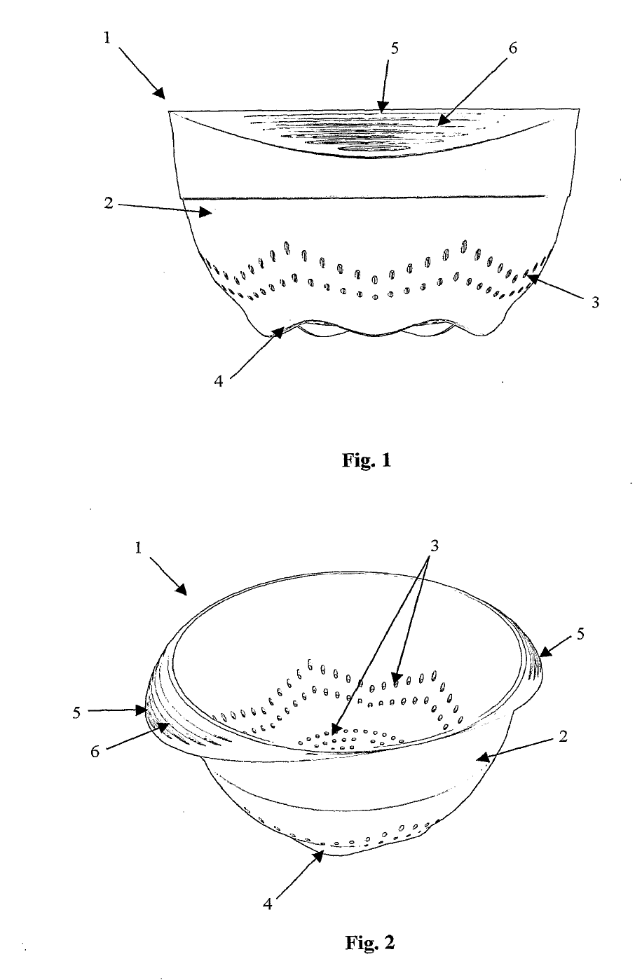

FIG. 1 is a side view of the colander;

FIG. 2 is a perspective view of the colander.

Referring to the drawings, numeral 1 generally designates a colander which comprises a spherical bowl-shaped container 2 having a plurality of through holes 3 on the bottom and/or side surfaces of the container, for draining water during straining.

The main feature of this patent is that the colander is wholly made of a flexible material, a flexible material being intended herein as a material that can recover important strains (50% minimum) with a hardness of 20 to 90 Shore A.

The materials used are preferably elastomers and more preferably silicone elastomers.

Silicone rubbers are not only suitable for their mechanical flexibility properties but also for their ability to maintain their mechanical properties in a wide range of temperatures (approximately −40° C. to +250° C.) and for their low heat conductivity.

Products made of this material are fabricated by molding a liquid or solid silicone elastomer-based mixture and subsequently cross-linking it, to provide the product with adequate elastic properties.

The colander is preferably made of silicone elastomers which use platinum as a catalyst in the cross-linking process.

The cross-linking process is carried out by adding appropriate catalysts to the elastomer mixture.

Platinum is a particularly advantageous catalyst, as it is non-toxic and prevents the generation of offensive smells.

Therefore, this catalyst is particularly suitable for products designed to come in direct contact with food.

Typically, the cross-linking process may occur at a temperature of 150° C. to 200° C for 30 seconds to 300 seconds.

Those skilled in the art may obviously appreciate that other flexible materials may be used, particularly thermoplastic rubbers, such as Santoprene, Thermoplast K, etc.

The flexibility imparted by the flexible material allows a more versatile use of the colander as a kitchen tool, due to its ability of being bent and adapted to various conditions of use.

For instance, the colander may be adapted to the openings of variously sized pots and used even in small sinks.

This colander further allows a better separation of the cooking water from foodstuffs, which may be directly strained in the colander container to facilitate water drain.

The colander turns to a considerably smaller size when it is stored and not used.

Its material further allows to fabricate low-cost colanders in a wide range of colors.

The colander made of flexible material is further easily washable.

The low heat conductivity of silicone rubbers or thermoplastic rubbers or elastomers further reduces the risk that the user may be burnt thereby, avoiding the use of insulating means for the colander handle.

According to the embodiment illustrated herein, the container 2 of the colander 1 has support means 4 at its bottom to stabilize the colander on a horizontal plane.

These support means 4 preferably consist of a ring-shaped member having a wavy profile, which provides a higher stability to the colander, even under load and assures water drainage during straining.

The container 2 preferably has two handles 5 at its top for holding the colander 1.

In the embodiment that is shown in the figures, the handles 5 are defined by two flaps, projecting from the upper rim of the spherical bowl which defines the colander and having a slightly arched profile.

Thus, the handles 5 also act as self-supporting elements of the spherical bowl 2.

The handles 5 are preferably shaped like half-moons, and may have non-slip protrusions 6, assuring a safer grip.

1. A colander comprising a bowl-shaped container, said container having a plurality of drainage through holes formed therein, wherein said container is wholly made of a flexible material.

2. A colander as claimed in claim 1, wherein said flexible material comprises of elastomers.

3. A colander as claimed in claim 2, wherein said elastomers comprise silicone elastomers.

4. A colander as claimed in claim 3, wherein said silicone elastomers are obtained by a platinum-catalyzed cross-linking process.

5. A colander as claimed in claim 2, wherein said elastomers comprise thermoplastic rubber.

6. A colander as claimed in claim 1, further comprises a ring having a wavy profile coupled to said container for acting as a support therefor.

7. A colander as claimed claim 1, further comprising a plurality of flap-like handles projecting out of the upper rim of said container.

8. A colander as claimed in claim 7, wherein said handles are shaped like half-moons and have an arched profile.

9. A colander as claimed in claim 7, wherein said handles have non-slip protrusions (6).

10-13. (canceled)

14. A colander as claimed in claim 1, wherein said flexible material has hardness of between 30 to 90 Shore A.

15. A colander as claimed in claim 2, wherein said elastomer has hardness of between 30 to 90 Shore A.

16. A colander as claimed in claim 3, wherein said silicon elastomer has hardness of between 30 to 90 Shore A.

17. A colander as claimed in claim 5, wherein said thermoplastic rubber has hardness of between 30 to 90 Shore A.

18. A colander as claimed in claim 1, further having an outer rim adaptable to the openings of variously sized pots.

19. A colander as claimed in claim 1, wherein said colander is convertible between a deployed state for straining liquids, and a stored state; and wherein in said stored state, said colander occupies a volume substantially smaller volume then volume said colander occupies in said deployed state.
